(19) United States
(12) Patent Application Publication
(10) Pub. No.: US 2026/0077517 A1
(43) Pub. Date: Mar. 19, 2026

(54) Retractable Pocket Clip for Knife

(71) Applicant: Kevin Michael Sayers, Sevierville, TN (US)

(72) Inventor: Kevin Michael Sayers, Sevierville, TN (US)

(21) Appl. No.: 19/398,901

(22) Filed: Nov. 24, 2025

Related U.S. Application Data
(63) Continuation of application No. 18/954,821, filed on Nov. 21, 2024.
(60) Provisional application No. 63/607,715, filed on Dec. 8, 2023.

(51) Int. Cl. B26B 5/00

(52) U.S. Cl. CPC B26B 5/003

(57) ABSTRACT

The present disclosure provides a retractable pocket clip assembly comprising a handle and a clip pivotally mounted to a carrier via a pivot pin and configured to pivot relative to the handle. The carrier is movably mounted to the handle and configured to move between retracted and extended positions. The assembly includes mounting springs configured to bias the clip toward a closed configuration and a locking mechanism configured to selectively retain the carrier between the retracted and extended positions. The locking mechanism comprises at least one locking ball and a carrier spring, with the carrier spring configured to bias the locking ball into engagement with at least one recess in the handle. The carrier moves from the retracted position to the extended position in response to force applied to an interior side of the clip.

### CROSS-REFERENCE TO RELATED APPLICATIONS

This application claims benefit of the following patent application(s) which is/are hereby incorporated by reference: U.S. application Ser. No. 18/954,821, titled OUT-THE-FRONT KNIFE, filed Nov. 21, 2025, and U.S. Provisional Ser. No. 63/607,715 , titled MECHANISM TO ACTUATE A BLADE, filed Dec. 8, 2023.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### FIELD OF INVENTION

The present disclosure relates to pocket clips for knives, and more particularly to a retractable pocket clip mechanism that can be selectively extended from and retracted into a knife handle.

### BACKGROUND

Pocket knives and folding knives have been widely used tools for centuries, valued for their portability, versatility, and safety when the blade is in the closed position. These cutting instruments commonly include a handle that houses one or more blades, with the blades configured to fold into or be stored in the handle when not in use.

In recent decades, pocket clips have become standard features on many knives and similar cutting tools. These clips are typically attached to the exterior of the knife handle and serve to secure the knife to a user's pocket, belt, or other article of clothing. Conventional pocket clips allow users to carry their knives in a more accessible manner while reducing the likelihood of loss or misplacement.

Traditional pocket clip designs generally include clips made from flexible materials such as stainless steel or titanium, which rely on the material's elasticity to provide spring force for retention. These clips are commonly manufactured through stamping or milling processes and are typically attached to the knife handle using screws or similar fasteners.

Typically, pocket clips extend outwardly from the knife handle, creating a permanent protrusion that adds to the overall profile of the tool. These clips remain in a fixed extended position during use and storage, maintaining constant contact with the user's pocket or clothing. The clips are designed to provide sufficient retention force to secure the knife while allowing for removal when needed.

Various attachment methods have been developed for mounting pocket clips to knife handles, including threaded fasteners, rivets, and integral manufacturing processes where the clip mounting features are formed as part of the handle during production. The positioning of clips on knife handles has also varied, with common locations including the side surfaces and spine areas of the handle.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a retractable pocket clip assembly is provided. The assembly includes a handle and a clip pivotally mounted to a carrier via a pivot pin and configured to pivot relative to the handle. The carrier is movably mounted to the handle and configured to move between a retracted position and an extended position. The assembly includes one or more mounting springs configured to bias the clip toward a closed configuration and a locking mechanism configured to selectively retain the carrier between the retracted position and the extended position.

According to other aspects of the present disclosure, the assembly may include one or more of the following features. The locking mechanism may comprise at least one locking ball and a carrier spring, with the carrier spring configured to bias the at least one locking ball into engagement with at least one recess in the handle. The retracted position may comprise an exterior surface of the clip positioned substantially flush with a surface of the handle. The carrier may be configured to move about 0.1 inches to about 0.4 inches between the retracted position and the extended position. The handle may comprise at least one recess configured to guide the carrier from moving beyond the retracted position and the extended position. The carrier may be configured to move from the retracted position to the extended position in response to a force applied to an interior side of the clip. The clip may be configured to pivot away from the handle at a distal end when depressed at a proximal end of the clip.

According to another aspect of the present disclosure, a cutting instrument is provided. The cutting instrument comprises a handle configured to receive at least one blade and a carrier positioned within the handle and configured to move between a retracted position wherein the carrier is recessed within the handle, and an extended position wherein the carrier extends outward from the handle. The cutting instrument includes a clip mounted to the carrier, a biasing element configured to bias the clip toward a closed configuration, and a detent system for maintaining the carrier in the retracted position or the extended position.

According to other aspects of the present disclosure, the cutting instrument may include one or more of the following features. The detent system may comprise at least one locking ball and a carrier spring, with the carrier spring configured to bias the at least one locking ball into engagement with at least one recess formed in the handle. The at least one locking ball may comprise two locking balls positioned at a first end and a second end of the carrier spring within the carrier. The carrier may be configured to move from about 0.1 inches to about 0.4 inches between the retracted position and the extended position. The handle may comprise at least one recess configured to guide the carrier from moving beyond predetermined limits in both the retracted position and the extended position. The clip may be configured to pivot away from the handle at a distal end. The carrier may be movable between the retracted position and the extended position in response to an object exerting force between an interior side of the clip and the handle.

According to a further aspect of the present disclosure, a method of operating a retractable clip is provided. The method comprises the steps of depressing a proximal end of a clip mounted on a carrier within a handle to pivot a distal end of the clip away from the handle, inserting an object to exert force between an interior side of the clip and the handle, applying the force against the interior side of the clip to move the carrier from a retracted position to an extended position, and securing the carrier in the extended position using a locking system within the handle.

According to other aspects of the present disclosure, the method may include one or more of the following features. The locking system may comprise at least one locking ball and a carrier spring, with the carrier spring configured to bias the at least one locking ball into engagement with one or more recesses formed in the handle. The method may further comprise biasing the clip toward the handle with at least one mounted spring between the clip and the carrier. The method may further comprise limiting movement of the carrier in either the retracted or extended position with at least one fixed stop within the handle. The method may further comprise depressing the clip and the carrier to return the carrier from the extended position to the retracted position. Depressing the clip and the carrier may cause an exterior surface of the clip to become substantially flush with the handle.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an exploded view of a retractable clip assembly.

FIG. 2 illustrates a perspective view of a knife with the clip in a retracted position.

FIG. 3 illustrates a side view of the knife of FIG. 2 with the clip pivoted away from a handle.

FIG. 4 illustrates a perspective view of the knife of FIG. 2 with the clip pivoted away from the handle.

FIG. 5 illustrates a side view of the knife with the carrier in an extended position.

FIG. 6 illustrates a perspective view of the knife with the carrier in the extended position.

FIG. 7 illustrates a sectional view of the knife of FIG. 2 showing internal components.

FIG. 8 illustrates a longitudinal cross-sectional view of the knife of FIG. 6.

FIG. 9 illustrates a transverse cross-sectional view of the retractable clip assembly in a retracted position.

FIG. 10 illustrates a transverse cross-sectional view of the retractable clip assembly in the extended position.

FIG. 11 illustrates a sectional view of the retractable clip assembly of FIG. 6.

FIG. 12 illustrates a sectional view of the retractable clip assembly of FIG. 2.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Reference will now be made in detail to embodiments of the present disclosure, one or more examples of which may be illustrated in the accompanying drawings. Each embodiment may be provided by way of explanation and not limitation of the present disclosure, and modifications and variations are possible without departing from the scope of the appended claims and their equivalents.

The present disclosure relates to a retractable pocket clip assembly that may address various limitations associated with traditional fixed pocket clips used on cutting instruments. Conventional pocket clips may create unwanted bulk, discomfort during handling, and aesthetic concerns due to their permanent protrusion from a handle surface. Additionally, traditional clips may be susceptible to damage from snagging and may lose their spring tension over time.

The retractable pocket clip assembly disclosed herein may provide a mechanism that allows a pocket clip to selectively extend from and retract into a handle of a cutting instrument. The assembly may be specifically designed for use with pocket knives and cutting instruments, where the clip can remain substantially flush with the handle surface when not in use, thereby eliminating bulk and improving the overall appearance and comfort of the cutting instrument. When needed, the clip may be deployed to function as a traditional pocket clip while providing enhanced durability and consistent spring force through a pivoting mechanism and detent system.

The retractable nature of the clip assembly may allow users to maintain the functional benefits of a pocket clip while addressing the aesthetic and practical concerns associated with permanently protruding clips. The assembly may incorporate a carrier system that moves between retracted and extended positions, allowing the clip to be selectively deployed based on user needs.

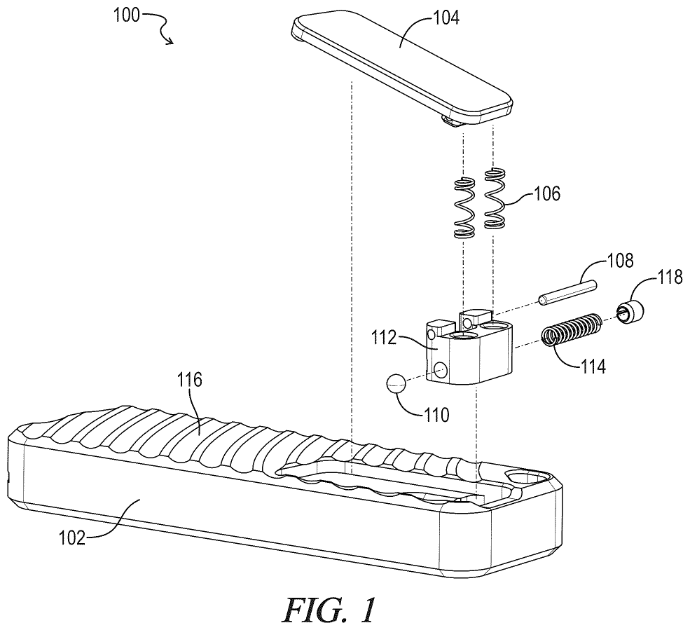

Referring to FIG. 1, an exploded view of a retractable clip assembly 100 may be illustrated showing the various components and their structural relationships. The clip assembly 100 may comprise a clip 104, mounted springs 106, carrier 112, carrier spring 114, at least one locking ball 110, pivot pin 108, and plunger 118, which may be incorporated with a handle 102 having a handle surface 116. The clip 104 may be pivotally connected to the carrier 112 through the pivot pin 108, allowing the clip 104 to pivot relative to the handle 102. The carrier 112 may be movably mounted to the handle 102 and may be configured to move between a retracted position and an extended position within the handle structure.

The mounted springs 106 may be positioned between the clip 104 and the carrier 112 and may be configured to bias the clip 104 toward a closed configuration, providing the spring force necessary for proper clip operation. In some aspects, the clip 104 may be constructed from flexible materials such as stainless steel or titanium, which may provide durability and corrosion resistance. The clip 104 may be manufactured through various processes including stamping or milling, allowing for precise dimensional control and surface finish characteristics.

As further shown in FIG. 1, a locking mechanism may be incorporated within the carrier 112 to selectively retain the carrier 112 between the retracted position and the extended position. The locking mechanism may comprise the at least one locking ball 110 and the carrier spring 114. In some aspects, the at least one locking ball 110 and carrier spring 114 may be contained within a hole in the carrier 112, providing a compact detent system. The plunger 118 may also be included as part of the locking mechanism, working in conjunction with the at least one locking ball 110 and carrier spring 114 to create a tactile detent system that maintains the carrier 112 in predetermined positions. The carrier spring 114 may be configured to bias the at least one locking ball 110 into engagement with corresponding recesses formed in the handle 102, thereby providing retention of the carrier 112 in both the retracted and extended positions.

Referring to FIG. 2-4, various views of the retractable pocket clip assembly may be illustrated showing a knife 202 with the clip 104 positioned in a retracted position 204. In the retracted position 204, the carrier 112 may be recessed within the handle 102, allowing the clip 104 to be positioned substantially flush with the handle surface 116. This configuration may eliminate the bulk and protrusion typically associated with conventional pocket clips, providing improved aesthetics and enhanced user comfort during handling of the knife 202.

As shown in FIG. 2, a perspective view of the knife 202 may demonstrate how the clip 104 may be positioned substantially flush with the handle surface 116 when the clip assembly 100 is in the retracted position 204. The flush positioning of the clip 104 may provide a streamlined profile that reduces snagging potential and maintains the visual appeal of the instrument. In some aspects, the clip 104 may be contoured or shaped to match the profile of the handle surface 116, further enhancing the flush appearance and tactile continuity of the handle 102.

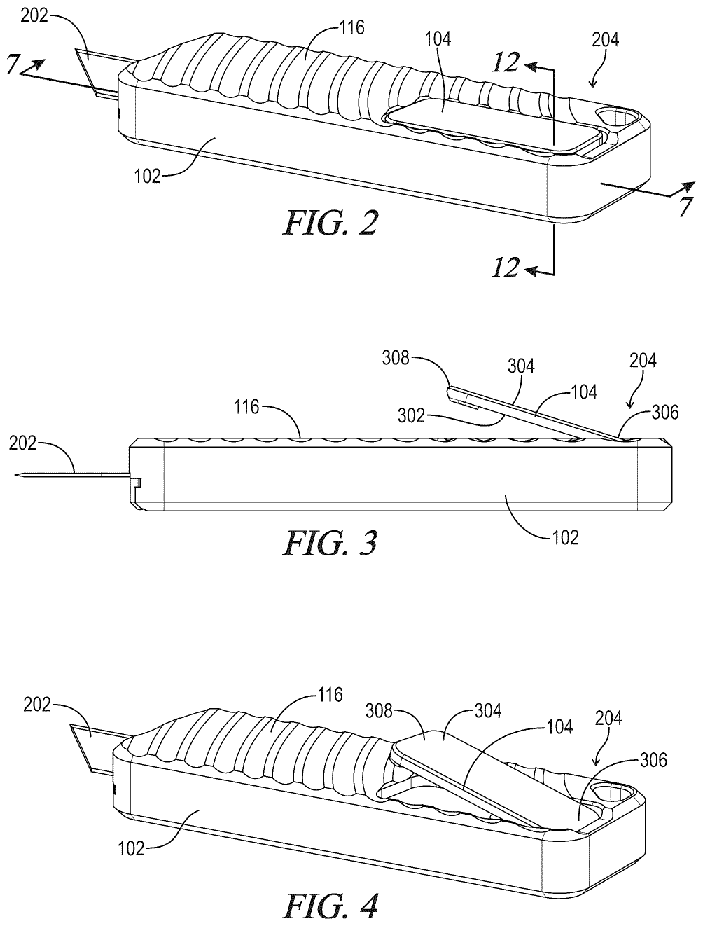

FIG. 3 may depict a side view of the assembly illustrating the clip 104 in a pivoted configuration while the carrier 112 remains in the retracted position 204. The clip 104 may include an exterior side of the clip 304 that faces outward from the handle 102 and an interior side of the clip 302 that faces inward with respect to the handle 102. The clip 104 may be configured to pivot away from the handle 102 at a distal end 308, creating an open configuration, when depressed at a proximal end 306. This pivoting action may expose the interior side of the clip 302, creating an opening between the interior side of the clip 302 and the handle surface 116. The pivoting mechanism may be facilitated by the pivot pin 108 and may be controlled by the mounted springs 106, which may bias the clip 104 toward the closed configuration with respect to the handle surface 116.

With reference to FIG. 4, another perspective view may show the relationship between the handle 102 and the clip 104 when the clip 104 is pivoted away from the handle 102 while the carrier 112 remains positioned in the retracted position 204. The distal end 308 of the clip 104 may pivot away from the handle surface 116, while the proximal end 306 may remain in contact with or in close proximity to the handle surface 116. This pivoting configuration may allow for the insertion of fabric or other materials between the interior side of the clip 302 and the handle surface 116, enabling the clip 104 to function as a pocket retention mechanism.

The pivoting capability of the clip 104 may provide operational flexibility while maintaining the compact profile of the retracted position 204. In some aspects, the proximal end 306 may include textured surfaces or ergonomic features to facilitate user manipulation and depression of the clip 104. The distal end 308 may be shaped or contoured to provide smooth insertion into pockets while minimizing fabric damage or snagging during use.

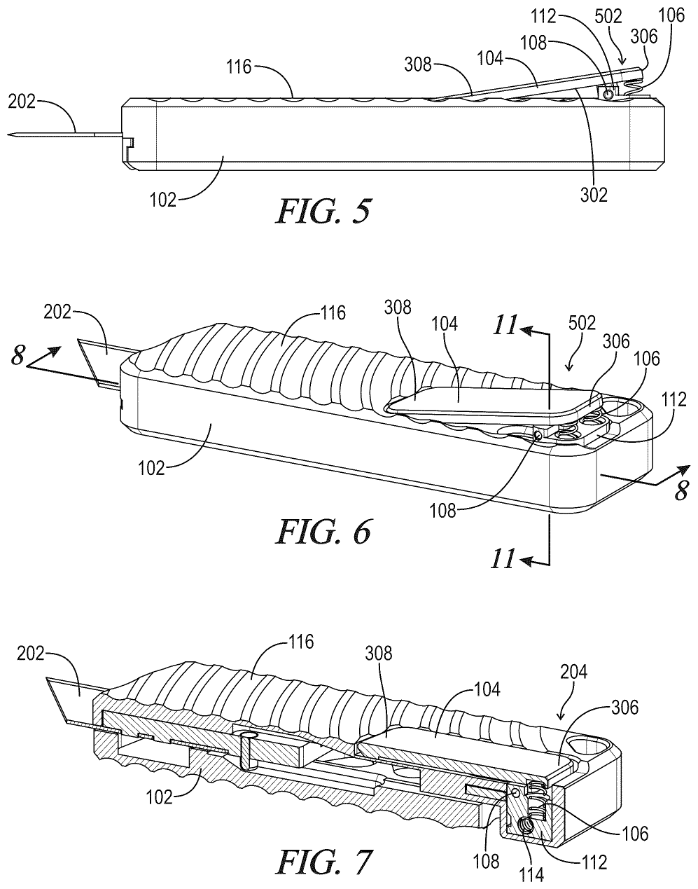

Referring to FIG. 5-6, the retractable pocket clip assembly may be illustrated in an extended position 502, wherein the carrier 112 may move outward from the handle 102 to accommodate operational requirements. In the extended position 502, the carrier 112 may extend from the handle 102 to provide increased clearance between the interior side of the clip 302 and the handle surface 116. This extended configuration may allow the clip assembly 100 to function as a traditional pocket clip while maintaining the structural advantages of the pivoting mechanism and detent system.

As shown in FIG. 5, a side view of the assembly may demonstrate the clip 104 mounted to the carrier 112 via the pivot pin 108 and the mounted springs 106, with the carrier 112 positioned in the extended position 502. The transition from the retracted position 204 to the extended position 502 may occur in response to a force applied to the interior side of the clip 302. When an object, such as fabric from a pocket, may be inserted between the interior side of the clip 302 and the handle surface 116, the object may exert force against the interior side of the clip 302, causing the carrier 112 to move outward from the handle 102 into the extended position 502.

The carrier 112 may be configured to move about 0.1 inches to about 0.4 inches between the retracted position 204 and the extended position 502, providing operational flexibility for various applications. In some aspects, the carrier 112 may be configured to move approximately 0.25 inches between the retracted position 204 and the extended position 502. This range of movement may accommodate different cloth thicknesses that may be inserted between the interior side of the clip 302 and the handle surface 116. The variable positioning capability may allow the clip assembly 100 to securely retain fabrics of varying thicknesses, from lightweight materials to heavier denim or canvas fabrics.

With continued reference to FIG. 5, the force exerted by an object against the interior side of the clip 302 may cause the carrier 112 to move from the retracted position 204 to the extended position 502, allowing the clip assembly 100 to automatically adjust to accommodate the thickness of the inserted material. The at least one locking ball 110 and carrier spring 114 may engage with corresponding recesses in the handle 102 to maintain the carrier 112 in the extended position 502 once the transition has occurred. This positioning capability may provide consistent retention force regardless of the specific cloth thickness encountered during use.

FIG. 6 may depict a perspective view showing the relationship between the handle 102, the clip 104, and the handle surface 116 when positioned with the carrier 1112 in the extended position 502. The extended configuration may provide clearance for fabric insertion while maintaining the structural integrity and operational characteristics of the clip assembly 100. The carrier 112 may remain securely positioned in the extended position 502 through the engagement of the locking mechanism, allowing for repeated insertion and removal of the instrument from a pocket without requiring manual adjustment of the carrier position.

As further shown in FIG. 7, a sectional view of the assembly may illustrate the internal configuration including the handle 102, the clip 104, the mounted springs 106, the pivot pin 108, the carrier 112, and the carrier spring 114. The sectional representation may demonstrate how the carrier 112 may be positioned within the handle 102 and how the various components may interact to provide the retractable functionality. For instance, the clip 104, and more specifically, the exterior side of the clip 308, is substantially flush with the handle surface 116. Additionally, the carrier spring 114 may be positioned to maintain engagement of the locking mechanism while allowing controlled movement of the carrier 112, shown here in the retracted position 204, between the retracted position 204 and the extended position 502.

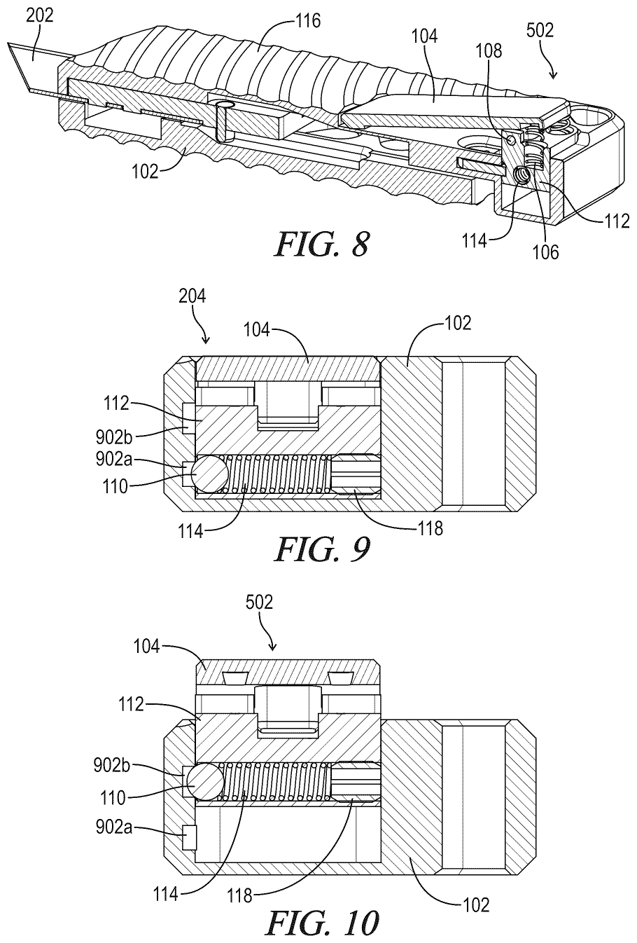

Referring to FIG. 8-10, cross-sectional views of the retractable pocket clip assembly may illustrate the internal configuration and structural relationships between the various components within the handle 102 and carrier 112. These cross-sectional representations may reveal the positioning and interaction of the mounted springs 106, pivot pin 108, carrier spring 114, at least one locking ball 110, plunger 118, and associated structural features that enable the retractable functionality of the clip assembly 100.

As shown in FIG. 8, a longitudinal cross-sectional view of the assembly may depict the handle 102 with the handle surface 116, the clip 104, the mounted springs 106, the pivot pin 108, the carrier 112, and the carrier spring 114. The longitudinal section may demonstrate how the carrier 112 may be positioned within the handle 102 in the extended position 502 and how the carrier spring 114 may extend along the length of the carrier 112 to provide the biasing force for the locking mechanism. The mounted springs 106 may be positioned between the clip 104 and the carrier 112, providing the biasing element configured to bias the clip 104 toward a closed configuration relative to the handle surface 116.

The pivot pin 108 may extend through the clip 104 and the carrier 112, providing the pivotal connection that allows the clip 104 to rotate relative to the carrier 112 and the handle 102. In some aspects, the pivot pin 108 may be constructed from hardened steel or other durable materials to withstand repeated pivoting operations and maintain dimensional stability over extended use periods. The carrier spring 114 may be positioned within the carrier 112 and may work in conjunction with the plunger 118 and at least one locking ball 110 to create the detent system for maintaining the carrier 112 in predetermined positions.

With reference to FIG. 9, a transverse cross-sectional view of the assembly may illustrate the handle 102, the clip 104, the at least one locking ball 110, the carrier 112, the carrier spring 114, the plunger 118, and at least one recess 902. The transverse section may reveal how the at least one locking ball 110 may be positioned within the carrier 112 and how the carrier spring 114 may bias the at least one locking ball 110 into engagement with the at least recess 902 formed in the handle 102. The at least one recess 902 may be configured to receive the at least one locking ball 110 and may provide a tactile detent that maintains the carrier 112 in the retracted position 204 or extended position 502. As shown in FIG. 9, the at least one locking ball 110 maintains the carrier 112 in the retracted position 204.

The at least one recess 902 may be machined or formed within the internal structure of the handle 102 and may be positioned to correspond with the location of the at least one locking ball 110 when the carrier 112 is in the retracted position 204 or extended position 502. In some aspects, the handle 102 may comprise multiple recesses configured to guide the carrier 112 from moving beyond predetermined limits in both the retracted position 204 and the extended position 502. The at least one recess 902 may have a contoured profile that allows the at least one locking ball 110 to engage smoothly while providing sufficient retention force to maintain the carrier 112 in the desired position.

The plunger 118 may be positioned at one end of the carrier spring 114 and may work in conjunction with the at least one locking ball 110 to create a balanced detent system. The carrier spring 114 may exert force on both the at least one locking ball 110 and the plunger 118, creating a symmetrical loading condition that may provide consistent engagement characteristics. In some aspects, the at least one locking ball 110 may comprise two locking balls positioned at a first end and a second end of the carrier spring 114 within the carrier 112, providing stability and retention capability.

As further shown in FIG. 10, another transverse cross-sectional view of the assembly may depict the configuration when the carrier 112 is positioned in the extended position 502. The cross-sectional view may illustrate the handle 102, the clip 104, the at least one locking ball 110, the carrier 112, the carrier spring 114, the plunger 118, and the at least one recess 902 in their relative positions when the carrier 112 has moved outward from the handle 102. The transition from the retracted position 204 to the extended position 502 may cause the at least one locking ball 110 to disengage from at least one recess 902a and engage with another at least one recess 902b corresponding to the extended position 502.

The carrier 112 may be configured to move between the retracted position 204 and the extended position 502 in response to forces applied during normal operation of the clip assembly 100. The detent system comprising the at least one locking ball 110, the carrier spring 114, and the plunger 118 may provide tactile feedback to the user during the transition between positions, allowing for intuitive operation of the retractable mechanism. The at least one recess 902b associated with the extended position 502 may be positioned to maintain the carrier 112 in the extended configuration until manual force is applied to the distal end 306 of the clip 104 to return the carrier 112 to the at least one recess 902a associated with the retracted position 204.

The internal configuration illustrated in the cross-sectional views may demonstrate how the various components may work together to provide a cutting instrument comprising the handle 102 configured to receive at least one blade, with the carrier 112 positioned within the handle 102 and configured to move between the retracted position 204 wherein the carrier 112 is recessed within the handle 102, and the extended position 502 wherein the carrier 112 extends outward from the handle 102. The clip 104 may be mounted to the carrier 112, and the mounted springs 106 may serve as the biasing element configured to bias the clip 104 toward the closed configuration, while the detent system may maintain the carrier 112 in either the retracted position 204 or the extended position 502 as required for proper operation.

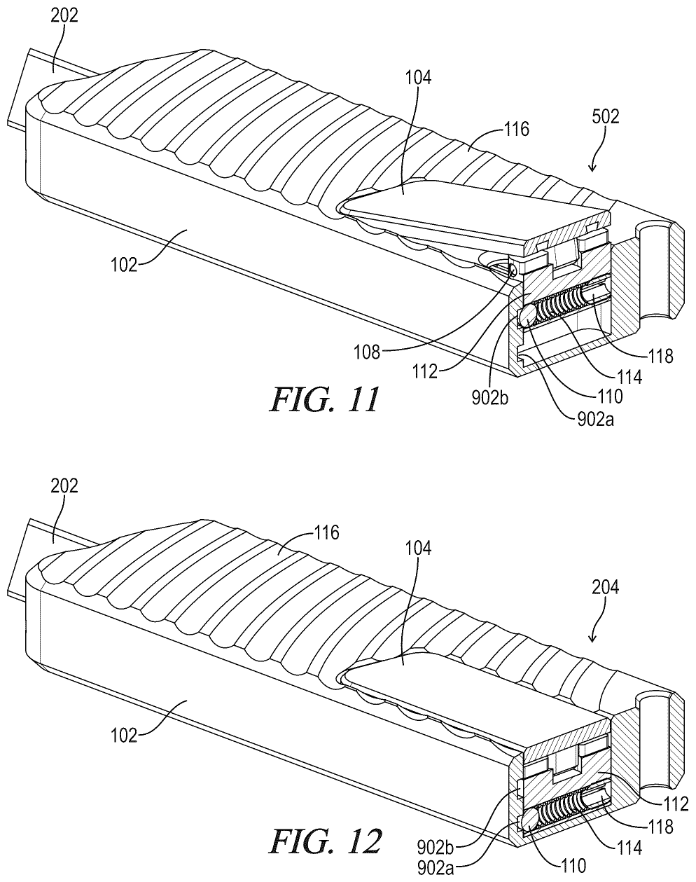

Referring to FIG. 11-12, sectional views of the retractable pocket clip assembly may illustrate the detailed configuration of the locking mechanism and detent system that maintains the carrier 112 in predetermined positions within the handle 102. The locking mechanism may comprise the at least one locking ball 110 and the carrier spring 114, with the carrier spring 114 configured to bias the at least one locking ball 110 into engagement with the at least one recess 902 formed in the handle 102. This engagement may provide secure retention of the carrier 112 in either the retracted position 204 or the extended position 502 while allowing controlled movement between these positions when operational forces are applied.

As shown in FIG. 11, the carrier 112 in the extended position 502 may contain the at least one locking ball 110 and the carrier spring 114 within a hole formed in the carrier 112. The hole may provide precise containment for the detent system components, ensuring proper alignment and operation of the locking mechanism. The carrier spring 114 may be positioned within the hole and may extend along the length of the contained space, providing the biasing force necessary to maintain engagement between the at least one locking ball 110 and the at least one recess 902. The plunger 118 may also be contained within the hole and may work in conjunction with the carrier spring 114 to create a balanced loading system.

The at least one recess 902 may be formed within the internal structure of the handle 102 and may be positioned to correspond with the location of the at least one locking ball 110 when the carrier 112 is positioned in the retracted position 204 or the extended position 502. The engagement between the at least one locking ball 110 and the at least one recess 902 may provide tactile detent feedback to the user during operation of the retractable clip assembly. This tactile feedback may allow users to sense when the carrier 112 has transitioned between positions and may provide confirmation that the carrier 112 is securely retained in the desired position.

As further shown in FIG. 12, the sectional view may illustrate the carrier 112 in the retracted position 204 containing the carrier spring 114, the at least one locking ball 110, and the plunger 118 within the drilled hole configuration. In some aspects, the at least one locking ball 110 may comprise two locking balls positioned at a first end and a second end of the carrier spring 114 within the carrier 112. This dual ball configuration may provide stability and retention capability by distributing the engagement forces across multiple contact points with corresponding recesses formed in the handle 102.

The handle 102 may comprise the at least one recess 902 configured to guide the carrier 112 from moving beyond the retracted position 204 and the extended position 502. These recesses may function as fixed stops that prevent the carrier 112 from moving too far out or in during operation, ensuring that the carrier 112 remains within predetermined operational limits. The fixed stops may be machined or formed as integral features of the handle 102 and may provide mechanical limits that prevent excessive movement of the carrier 112 in either direction.

The fixed stops may be positioned to correspond with the maximum travel limits of the carrier 112, ensuring that the carrier 112 cannot extend beyond the extended position 502 or retract beyond the retracted position 204. This limitation may prevent damage to the internal components and may maintain proper operational clearances between the clip 104 and the handle surface 116. The fixed stops may also provide structural support for the carrier 112 during operation, distributing operational loads across the handle structure and maintaining the integrity of the retractable mechanism over extended use periods.

The retractable pocket clip assembly may function as an integrated system wherein multiple components work in coordination to provide selective deployment and retraction capabilities. The system may incorporate both pivotal and linear motion mechanisms that operate independently yet cooperatively to achieve the desired retractable functionality. The clip may be configured to pivot relative to the carrier while the carrier simultaneously moves linearly within the handle, creating a dual-motion system that accommodates various operational requirements.

The mounted springs 106 may provide the primary biasing force that maintains the clip 104 in a closed configuration relative to the handle surface 116. The biasing force generated by the mounted springs 106 may be calibrated to provide sufficient retention force for secure pocket attachment while allowing controlled opening of the clip 104 when manual force is applied to the proximal end 306. The mounted springs 106 may be positioned between the clip 104 and the carrier 112, creating a mechanical connection that transfers operational forces between these components while maintaining the desired spring characteristics.

The carrier 112 may serve as an intermediate component that facilitates both the pivotal motion of the clip 104 and the linear translation of the entire clip assembly 100 within the handle 102. The carrier 112 may be movably mounted within the handle 102 through a sliding interface that allows controlled movement between the retracted position 204 and the extended position 502. The sliding interface may incorporate bearing surfaces or guide features that maintain proper alignment of the carrier 112 during movement while minimizing friction and wear over extended operational cycles.

The pivot pin 108 may create a mechanical connection between the clip 104 and the carrier 112 that allows rotational movement of the clip 104 relative to the carrier 112 while maintaining structural integrity of the assembly. The pivot pin 108 may be secured within the carrier 112 and may extend through corresponding holes or slots in the clip 104, creating a hinged connection that defines the axis of rotation for the clip 104. The pivot pin 108 may be positioned to optimize the mechanical advantage of the clip 104 during opening and closing operations, ensuring that minimal force is required for clip deployment while maintaining adequate retention force.

The locking mechanism may interact with both the carrier 112 and the handle 102 to provide selective retention of the carrier 112 in predetermined positions. The locking mechanism may operate independently of the clip 104 pivoting motion, allowing the carrier 112 to move between retracted position 204 and extended position 502 regardless of the current pivotal position of the clip 104. The carrier spring 114 within the locking mechanism may provide continuous biasing force that maintains engagement between the at least one locking ball 110 and the corresponding at least one recess 902 in the handle 102, ensuring secure retention until sufficient force is applied to overcome the detent engagement.

The operational sequence of the system may begin with the clip 104 in a closed configuration and the carrier 112 in the retracted position 204, wherein the clip 104 remains substantially flush with the handle surface 116. Manual depression of the proximal end 306 of the clip 104 may cause the distal end 308 to pivot away from the handle surface 116, creating an opening between the interior side of the clip 302 and the handle 102. The pivoting motion may occur while the carrier 112 remains in the retracted position 204, demonstrating the independent nature of the pivotal and linear motion systems.

When an object is inserted between the interior side of the clip 302 and the handle surface 116, the object may exert force against the interior side of the clip 302 that is transmitted through the clip 104 to the carrier 112 via the pivot pin 108 connection. This force may overcome the detent engagement of the locking mechanism, causing the carrier 112 to move linearly outward from the handle 102 into the extended position 502. The movement of the carrier 112 may increase the clearance between the clip 104 and the handle surface 116, accommodating objects of varying thickness while maintaining secure retention through the biasing force of the mounted springs 106.

The transition from the retracted position 204 to the extended position 502 may occur automatically in response to the insertion force, requiring no additional manual manipulation by the user. Alternatively, a user may apply additional force, if needed, to transition the carrier 112 from the retracted position 204 to the extended position 502. For example, once an object has been inserted between the clip 104 and handle surface 116, a user may apply force to the distal end 308, effectively pulling the carrier 112 up to the extended position 502. The locking mechanism may engage with the corresponding at least one recess 902 associated with the extended position 502, securing the carrier 112 in the extended configuration. The clip 104 may continue to function as a traditional pocket clip while the carrier 112 remains in the extended position 502, with the mounted springs 106 providing the necessary retention force for secure attachment to fabric or other materials.

The return of the system to the retracted position 204 may be accomplished through manual application of force to the clip 104 and carrier 112 assembly. A user may apply force to the proximal end 306 of the clip 102, where the clip 102 and carrier 112 join, to transition the carrier 112 from the extended position 502 to the retracted position 204. Depression of the clip 104 and carrier 112 may overcome the detent engagement of the locking mechanism, allowing the carrier 112 to move linearly inward toward the retracted position 204. The locking mechanism may engage with the at least one recess 902a corresponding to the retracted position 204, securing the carrier 112 and allowing the clip 104 to return to a substantially flush configuration with the handle surface 116.

The dual-motion capability of the system may provide operational flexibility that accommodates various user preferences and application requirements. The independent operation of the pivotal and linear motion systems may allow users to deploy the clip 104 partially for initial insertion while relying on the extension capability to accommodate different material thicknesses. The system may maintain consistent operational characteristics regardless of the number of deployment and retraction cycles, with the spring-loaded mechanisms providing reliable performance over extended use periods.

The method of operating a retractable clip may involve a sequence of coordinated actions that enable selective deployment and retraction of the clip assembly 100. The operational method may begin with the clip 104 in a closed configuration and the carrier 112 positioned in the retracted position 204, wherein an exterior surface of the clip 104 may be positioned substantially flush with a handle surface 116. The method may provide users with intuitive control over the clip 104 deployment while accommodating various operational requirements and material thicknesses.

The initial step of the operational method may involve depressing a proximal end 306 of a clip 104 mounted on a carrier 112 within a handle 102 to pivot a distal end 308 of the clip 104 away from the handle 102. This depression action may overcome the biasing force provided by at least one mounted spring 106 positioned between the clip 104 and the carrier 112, allowing the distal end 308 to rotate outward from the handle surface 116. The pivoting motion may create an opening between an interior side of the clip 302 and the handle 102, providing access for object insertion. The proximal end 306 depression may require minimal force while providing sufficient mechanical advantage to open the clip 104 against the spring bias.

Following the initial clip 104 opening, the method may continue with inserting an object to exert force on the interior side of the clip and/or between the interior side of the clip 302 and the handle 102. The object insertion may involve positioning fabric, such as pocket material, or other items within the opening created by the pivoted clip 104. The insertion process may be facilitated by the open configuration of the clip 104, allowing smooth entry of the object without requiring excessive manipulation or force. The object may be positioned to make contact with the interior side of the clip 302, establishing the force necessary for subsequent carrier 112 movement.

The method may proceed with applying the force against the interior side of the clip 302 to move the carrier 112 from a retracted position 204 to an extended position 502. The force application may occur as the object exerts pressure against the interior side of the clip 302 during insertion or positioning operations. This force may be transmitted through the clip 104 to the carrier 112, overcoming the engagement of a locking system and causing the carrier 112 to move linearly outward from the handle 102. The carrier 112 movement may increase the clearance between the clip 104 and the handle 102, accommodating objects of varying thickness while maintaining operational functionality.

The operational sequence may include securing the carrier 112 in the extended position 502 using a locking system within the handle 102. The locking system may comprise at least one locking ball 110 and a carrier spring 114, with the carrier spring 114 configured to bias the at least one locking ball 110 into engagement with at least one recess 902 formed in the handle 102. The engagement between the at least one locking ball 110 and the at least one recess 902 may provide tactile feedback and secure retention of the carrier 112 in the extended position 502. The locking system may maintain the carrier 112 position without requiring continuous user input, allowing the clip 104 to function as a traditional pocket retention mechanism.

The method may further comprise biasing the clip 104 toward the handle 102 with the at least one mounted spring 106 between the clip 104 and the carrier 112. The biasing action may provide the retention force necessary for secure attachment to fabric or other materials while allowing controlled opening when manual force is applied. The mounted spring 106 may maintain consistent biasing characteristics throughout the operational cycle, ensuring reliable clip 104 performance regardless of the carrier 112 position. The spring bias may be calibrated to provide adequate retention force without requiring excessive insertion force during object placement.

The operational method may additionally include limiting movement of the carrier 112 in either the retracted position 204 or extended position 502 with at least one recess 902 within the handle 102. The at least one recess 902 may prevent the carrier 112 from moving beyond predetermined operational limits, protecting the internal components from damage and maintaining proper clearances. The at least one recess 902 may provide mechanical limits that define the maximum travel range of the carrier 112, ensuring consistent operational characteristics and preventing excessive movement that could compromise the functionality of the retractable mechanism.

The method may incorporate a reverse operational sequence involving depressing the clip 104 and the carrier 112 to return the carrier 112 from the extended position 502 to the retracted position 204. This return operation may require manual application of force to overcome the locking system engagement and initiate carrier 112 movement toward the retracted position 204. The depression action may be applied to both the clip 104 and carrier 112 assembly, creating sufficient force to disengage the at least one locking ball 110 from the at least one recess 902b associated with the extended position 502 and allow linear movement of the carrier 112 inward toward the handle 102.

The reverse operation may result in the exterior surface of the clip 104 becoming substantially flush with the handle 102 when the carrier 112 reaches the retracted position 204. The flush positioning may eliminate the bulk and protrusion associated with traditional pocket clips, restoring the streamlined profile of the handle 102. The locking system may engage with the recess 902 corresponding to the retracted position 204, securing the carrier 112 and maintaining the flush configuration until subsequent deployment is required.

The operational method may accommodate variations in step order, as the sequence may be adapted to specific user preferences or application requirements unless expressly required otherwise. The method may provide flexibility in operation while maintaining the functional benefits of both pivotal and linear motion systems. The coordinated operation of the biasing elements, locking system, and mechanical components may ensure reliable performance throughout repeated operational cycles, providing users with consistent and predictable clip 104 behavior during deployment and retraction operation.

The embodiments described herein are provided as illustrative examples of the present disclosure and are not intended to limit the scope of the disclosure to the specific configurations, materials, or operational methods described. Various modifications and variations may be made to the retractable pocket clip assembly without departing from the spirit and scope of the disclosure. Such modifications may include alternative materials for construction of the components, different spring configurations, varied detent mechanisms, alternative carrier movement ranges, and modified handle configurations that accommodate the retractable functionality.

The structural relationships, dimensional specifications, and operational characteristics described may be adapted to suit specific application requirements while maintaining the fundamental principles of the retractable clip mechanism. Alternative embodiments may incorporate different locking mechanisms, varied spring arrangements, or modified carrier configurations that provide similar functional benefits. The materials, manufacturing processes, and assembly methods may be selected based on specific performance requirements, cost considerations, or aesthetic preferences without departing from the scope of the disclosure.

It is intended that the present disclosure covers such modifications and variations as come within the scope of the appended claims and their equivalents. The scope of protection is defined by the claims that follow, and the detailed description provided herein serves to enable those skilled in the art to make and use the retractable pocket clip assembly in its various embodiments and applications.

A number of implementations have been described. Nevertheless, it will be understood that various modifications may be made without departing from the spirit and scope of the disclosure. Accordingly, other implementations are within the scope of the following claims.

1. A retractable pocket clip assembly, comprising:
a handle;
a clip pivotally mounted to a carrier via a pivot pin and configured to pivot relative to the handle;
the carrier movably mounted to the handle and configured to move between a retracted position and an extended position;
one or more mounting springs configured to bias the clip toward a closed configuration; and
a locking mechanism configured to selectively retain the carrier between the retracted position and the extended position.

2. The assembly of claim 1, wherein the locking mechanism comprises at least one locking ball and a carrier spring, the carrier spring configured to bias the at least one locking ball into engagement with at least one recess in the handle.

3. The assembly of claim 1, wherein the retracted position comprises an exterior surface of the clip positioned substantially flush with a surface of the handle.

4. The assembly of claim 1, wherein the carrier is configured to move about 0.1 inches to about 0.4 inches between the retracted position and the extended position.

5. The assembly of claim 1, wherein the handle comprises at least one recess configured to guide the carrier from moving beyond the retracted position and the extended position.

6. The assembly of claim 1, wherein the carrier is configured to move from the retracted position to the extended position in response to a force applied to an interior side of the clip.

7. The assembly of claim 1, wherein the clip is configured to pivot away from the handle at a distal end when depressed at a proximal end of the clip.

8. A cutting instrument comprising:
a handle configured to receive at least one blade;
a carrier positioned within the handle and configured to move between a retracted position wherein the carrier is recessed within the handle, and an extended position wherein the carrier extends outward from the handle;
a clip mounted to the carrier;
a biasing element configured to bias the clip toward a closed configuration; and
a detent system for maintaining the carrier in the retracted position or the extended position.

9. The cutting instrument of claim 8, wherein the detent system comprises at least one locking ball and a carrier spring, the carrier spring configured to bias the at least one locking ball into engagement with at least one recess formed in the handle.

10. The cutting instrument of claim 9, wherein the at least one locking ball comprises two locking balls positioned at a first end and a second end of the carrier spring within the carrier.

11. The cutting instrument of claim 8, wherein the carrier is configured to move from about 0.1 inches to about 0.4 inches between the retracted position and the extended position.

12. The cutting instrument of claim 8, wherein the handle comprises at least one recess configured to guide the carrier from moving beyond predetermined limits in both the retracted position and the extended position.

13. The cutting instrument of claim 8, wherein the clip is configured to pivot away from the handle at a distal end.

14. The cutting instrument of claim 8, wherein the carrier is moveable between the retracted position and the extended position in response to an object exerting force between an interior side of the clip and the handle.

15. A method of operating a retractable clip, comprising the steps of:
depressing a proximal end of a clip mounted on a carrier within a handle to pivot a distal end of the clip away from the handle;
inserting an object to exert force between an interior side of the clip and the handle;
applying the force against the interior side of the clip to move the carrier from a retracted position to an extended position; and
securing the carrier in the extended position using a locking system within the handle.

16. The method of claim 15, wherein the locking system comprises at least one locking ball and a carrier spring, the carrier spring configured to bias the at least one locking ball into engagement with one or more recesses formed in the handle.

17. The method of claim 15, further comprising:
biasing the clip toward the handle with at least one mounted spring between the clip and the carrier.

18. The method of claim 15, further comprising:
limiting movement of the carrier in either the retracted or extended position with at least one fixed stop within the handle.

19. The method of claim 15, further comprising:
depressing the clip and the carrier to return the carrier from the extended position to the retracted position.

20. The method of claim 19, wherein depressing the clip and the carrier causes an exterior surface of the clip to become substantially flush with the handle.
